(19) United States
(12) Patent Application Publication
(10) Pub. No.: US 2004/0099436 A1
(43) Pub. Date: May 27, 2004

(54) Electric cord and loudspeaker using the electric cord

(75) Inventors: Koji Maekawa, Tendo-shi (JP); Hiroyuki Kobayashi, Tendo-shi (JP)

Correspondence Address: YOUNG & THOMPSON, 745 SOUTH 23RD STREET 2ND FLOOR, ARLINGTON, VA, 22202

(73) Assignee: PIONEER CORPORATION, TOKYO-TO (JP)

(21) Appl. No.: 10/714,848

(22) Filed: Nov. 18, 2003

(30) Foreign Application Priority Data
Nov. 25, 2002 (JP) 2002-340653

(51) Int. Cl. H01B 5/08

(52) U.S. Cl. 174/128.1

(57) ABSTRACT

A wire is obtained by winding a conductor on a center core obtained by twisting a plurality of core threads, and the surface of the conductor is covered with an insulator. As the conductor, a rectangular wire having a rectangular section is preferably used rather than a round wire with respect to volume occupation. The plurality of wires, e.g., three wires, constitute a wire rod. These three wires are twisted, woven, or bundled to form a wire rod. Three wire rods are twisted, woven, or bundled to form an electric cord. A loudspeaker uses the electric cord, and the electric cord is used as a signal input line for a voice coil.

### BACKGROUND OF THE INVENTION

1. Field of the Invention

The present invention relates to the technical field of an electric cord for electrically connecting a vibrator and an input terminal to which a drive signal for driving the vibrator is inputted and a loudspeaker using the electric cord.

2. Description of Prior Art

In recent years, a loudspeaker has been required to output voice with high quality due to the popularization of high-quality music sources and required to output voice with less distortion in response to a high-frequency component or a high-power input. For this reason, the constituent elements of a loudspeaker have been variously researched and developed. Of these elements, an electric cord for inputting a drive signal to a voice coil has been required to have predetermined characteristics at a resistance and intensity, and studied.

Electric cords in such circumstances comprise, e.g., shapes shown in FIGS. 1 to 3. As shown in the perspective view in FIG. 1A and a sectional view in FIG. 1B, a plurality of wires la (e.g., three wires) each obtained by winding a conductor 12 on a plurality of core threads 11 are twisted, woven, or bundled to form a wire rod 1b. A plurality of wire rods 1b (e.g., three wire rods) are twisted, woven, or bundled to obtain an electric cord 1 shown in FIG. 3. At this time the wire 1a of the electric cord 1 is not insulated from another wire 1a, and the respective wires 1a are in contact with adjacent wires 1a with predetermined contact resistance.

When the electric cord described above is used as an input line for a drive signal to a loudspeaker, a diaphragm of the loudspeaker vibrates together with the electric cord, and a contact state between the wires changes, or the wire may disconnect. Due to such changes in contact states, changes in contact resistance, and disconnection, contact and non-contact states between wires adjacent to a disconnection portion are alternated to change a resistance at the signal input terminal of the electric cord. For this reason, a current flowing in a voice coil varies to generate noise.

### SUMMARY OF THE INVENTION

The present invention, therefore, has been made in consideration of the above problems. It is an object to be solved by the present invention to provide an electric cord whose resistance does not vary at a signal input terminal even though a contact state between adjacent wires changes because of the electric cord's vibration, or even though a contact state between the adjacent wires changes because of a wire's disconnection. In addition, it is another object of the present invention to provide a loudspeaker in which the electric cord is used as a signal input line for a voice coil to make it possible to reproduce high-quality voice.

The above object of the present invention can be achieved by an electric cord provided with: a plurality of wires which electrically connect a vibrator and an input terminal to which a drive signal for driving the vibrator is inputted, wherein the respective wires are electrically insulated from each other.

The above object of the present invention can be achieved by a loudspeaker using the above electric cord, and the electric cord is used as a signal input line for a voice coil.

The nature, utility, and further features of this invention will be more clearly apparent from the following detailed description with respect to preferred embodiments of the invention when read in conjunction with the accompanying drawings briefly described below.

### BRIEF DESCRIPTION OF THE DRAWINGS

FIGS. 1A and 1B are views showing the structure of a conventional wire, in which FIG. 1A is a perspective view and FIG. 1B is a sectional view.

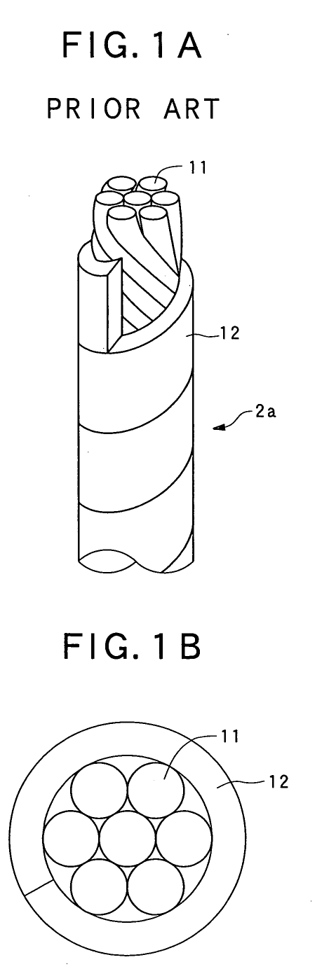

FIG. 2 is a sectional view of a wire rod formed by using three wires shown in FIG. 1.

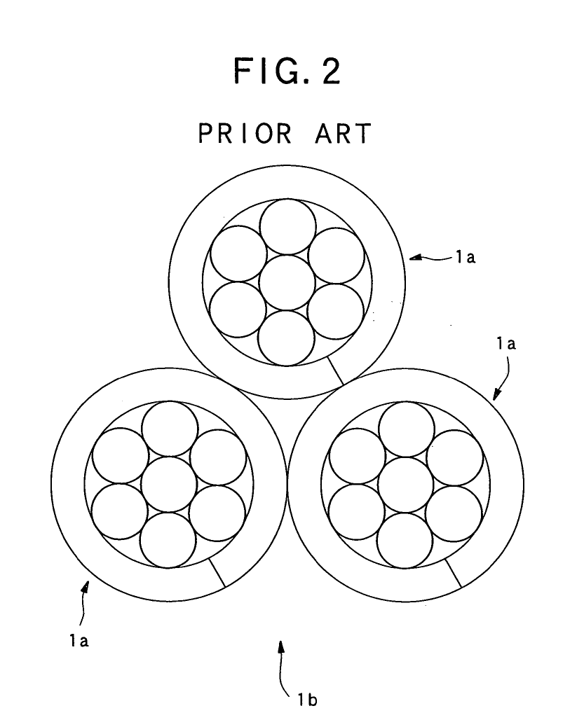

FIG. 3 is a sectional view of a conductive lead formed by using three wire rods shown in FIG. 2.

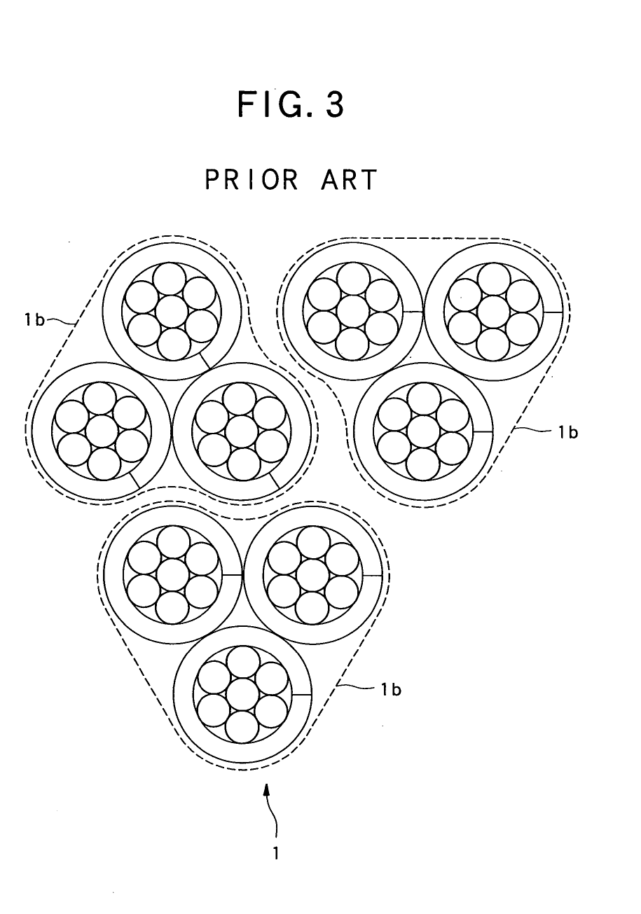

FIGS. 4A and 4B are views showing the structure of a wire according to the first embodiment of the present invention, in which FIG. 4A is a perspective view and FIG. 4B is a sectional view.

FIG. 5 is a sectional view of a wire rod formed by using three wires shown in FIGS. 4A and 4B.

FIG. 6 is a sectional view of an electric cord formed by using three wire rods shown in FIG. 5.

FIGS. 7A and 7B are views showing the structure of a wire according to the second embodiment of the present invention, in which FIG. 7A is a perspective view and FIG. 7B is a sectional view.

FIGS. 8 is a sectional view of a wire rod formed by using three wires shown in FIGS. 7A and 7B.

FIG. 9 is a sectional view of an electric cord formed by using three wire rods shown in FIG. 8.

FIG. 10 is a sectional view of a loudspeaker to which an electric cord according to the present invention is applied.

### DETAILED DESCRIPTION OF THE PREFERRED EMBODIMENTS

An aspect of the present invention will be described below.

An electric cord according to an aspect of the present invention is provided with: a plurality of wires which electrically connect a vibrator and an input terminal to which a drive signal for driving the vibrator is inputted, wherein the respective wires are electrically insulated from each other.

An electric cord according to an aspect of the present invention is constituted by a plurality of wires, and the respective wires are electrically insulated from each other. When this electric cord is used as a conductive lead for electrically connecting an input terminal attached to a frame and a voice coil, e.g., as an input line to a voice coil of a loudspeaker, the conductive lead vibrates between the voice coil bobbin of the loudspeaker and the terminal depending on an input signal. This vibration changes the contact state between adjacent wires. However, since the respective wires are electrically insulated form each other, the wires have no contact resistance in the contact state. Therefore, contact resistance does not change in case of an electric cord of the present invention, whereas a change in contact resistance generates in case of a conventional electric cord. For this reason, acoustic noise is not generated by the change in contact resistance, and high-quality voice can be reproduced.

Even though some wires are disconnected due to the vibration to bring the disconnection portion into contact with an adjacent wire, a change in resistance caused by alternating connection and non-connection states does not occur because the wires are insulated from each other. An electromagnetic noise is prevented from being generated by alternating the connection and non-connection states, and high-quality voice can be reproduced.

The electric cord of the present invention can be applied not only to a loudspeaker but also to an apparatus in which a vibrator and an input terminal inputted a drive signal for driving the vibrator are electrically connected to each other. For example, the electric cord can be used in electronics such as a bodysonic apparatus which is adversely affected by electromagnetic noise generated by a change in contact resistance of an electric cord, a change in resistance caused by disconnection, alternation of contact and non-contact states of a disconnection portion, and the like.

The electric cord according to one aspect of the present invention is formed by at least one of twisting, weaving, and bundling a plurality of wire rods each of which is formed by at least one of twisting, weaving, and bundling of the plurality of wires.

According to this aspect, a plurality of wires are twisted, woven, or bundled to form a wire rod. A plurality of the wire rods are twisted, woven, or bundled to form an electric cord according to the present invention. The electric cord formed in this manner is highly flexible and has a low dynamic resistance for vibration in a vibrational environment. For example, when the electric cord is used as a signal input line of a loudspeaker, the electric cord scarcely restrains a voice coil, i.e., a diaphragm, from moving, and disconnection rarely occurs.

In the electric cord according to another aspect of the present invention, the wire is constituted by a core thread and a conductor winded on the surface of the core thread, and the surface of the conductor is covered with an insulator.

According to this aspect, a wire has a structure in which a conductor having a surface covered with an insulator is winded on a core thread. Since the surface of the conductor is covered with the insulator, the wire is electrically insulated from another wire. An electric cord constituted by the wires each having the above structure has the above advantage.

In the electric cord according to further aspect of the present invention, the wire is constituted by a core thread and a conductor winded on the surface of the core thread, and the surface of the wires is covered with an insulator.

According to this aspect, a wire has a structure in which a conductor is winded on a core thread, and the surface of the wire is covered with an insulator. Since the surface of the wire is covered with the insulator, the wire is electrically insulated from another wire. An electric cord constituted by the wires each having the above structure has the above advantage.

In the electric cord according to furthermore aspect of the present invention, the conductor is a rectangular conductor having a rectangular section.

According to this aspect, a conductor winded on a core thread has a rectangular section. A space factor, i.e., a winding density is greater in a conductor having a rectangular section than in a conductor having a circular section. In the conductor having a rectangular section, a large current can be obtained with respect to a predetermined winding section, and when the electric cord is used in a loudspeaker, greater drive force of a diaphragm can be obtained. The conductor may have a surface covered with an insulator, or may be winded on a core thread, and the resultant structure may be covered with an insulator.

A loudspeaker according to an aspect of the present invention uses the above electric cord, and the electric cord is used as a signal input line for a voice coil.

In a loudspeaker according to the aspect of the present invention, an electric cord according to the present invention is used as a signal input line for a voice coil and as a conductive lead for electrically connecting a voice coil of the loudspeaker and an input terminal attached to a frame. The electric cord according to the present invention has no change in contact resistance, and does not alternate electric contact and non-contact states to an adjacent wire due to disconnection. A mechanical resistance is low with respect to vibration of the voice coil, and high-quality voice can be reproduced.

The above operation and other advantages will be apparent from the embodiments described below.

### FIRST EMBODIMENT

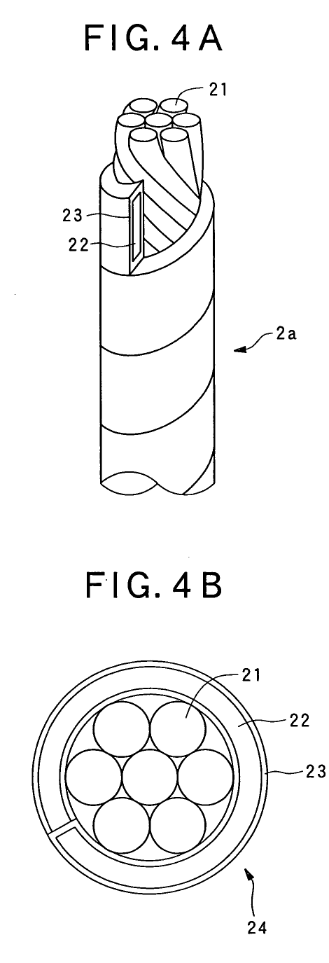

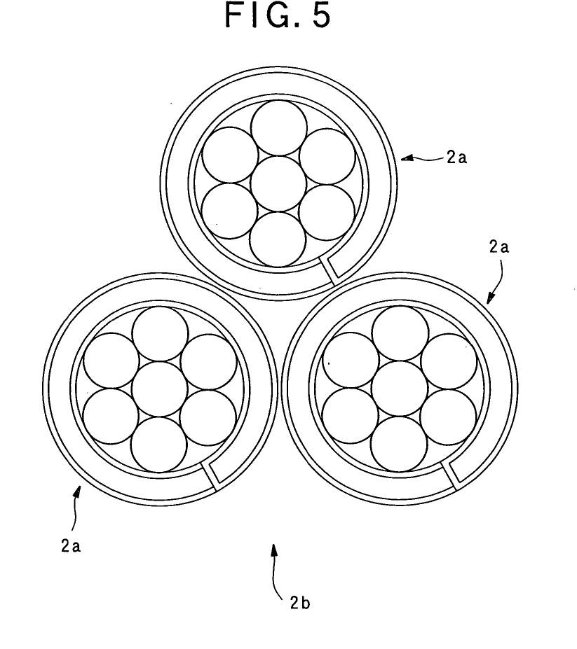

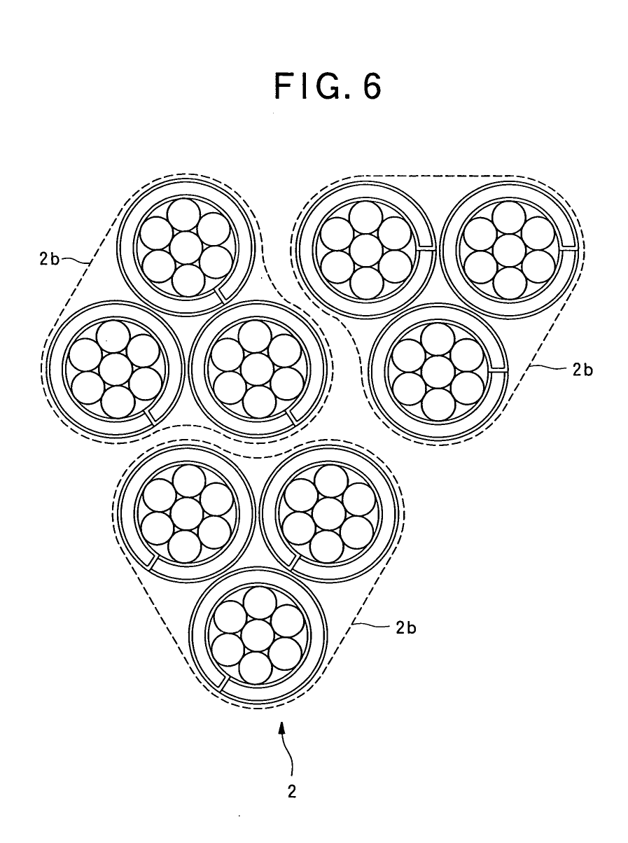

The first embodiment in which an electric cord according to the present invention is applied as a conductive lead for a loudspeaker will be described below with reference to FIGS. 4 to 6. FIGS. 4A and 4B are views showing the structure of a wire according to the first embodiment of the present invention, in which FIG. 4A is a perspective view and FIG. 4B is a sectional view. FIG. 5 is a sectional view of a wire rod formed by using three wires shown in FIGS. 4A and 4B. FIG. 6 is a sectional view of an electric cord (conductive lead for a loudspeaker) formed by using three wire rods shown in FIG. 5.

As shown in FIGS. 4A and 4B, a wire 2a is obtained by winding a conductor 22 on a center core obtained by twisting a plurality of core threads 21, and the surface of the conductor 22 is covered with an insulator 23. As the insulator 23, a predetermined insulating material such as enamel is used. As the conductor 22, a rectangular wire having a rectangular section is preferably used rather than a round wire in terms of volume occupation. More specifically, a larger current can be passed through the conductor 22 without increasing the area of the winding section.

A plurality of wires 2a shown in FIGS. 4A and 4B, e.g., three wires, constitute a wire rod 2b as shown in the sectional view in FIG. 5. The three wires 2a are twisted, woven, or bundled to form the wire rod 2b. A plurality of wire rods 2b constitute an electric cord.

A plurality of wire rods 2b shown in FIG. 5, e.g., three wire rods 2b, constitute the electric cord 2 as shown in FIG. 6. These three wire rods 2b are twisted, woven, or bundled to form the electric cord 2.

The electric cord 2 having the above structure comprises the wires 2a whose surfaces are insulated. For this reason, one wire 2a is not in electric contact with another wire 2a. A conductor for inputting a signal to a loudspeaker has one end fixed to an input terminal attached to a frame and the other end connected to a voice coil. For this reason, the conductor is vibrated and deformed. In particular, when a high-frequency signal is inputted, or when a high voltage is inputted, the vibration or deformation becomes conspicuous.

The application of vibration or deformation changes the contact state between the wire 2a and another adjacent wire 2a to disconnect the wire 2a. However, even though the contact state between the wire 2a having a surface covered with an insulator and another adjacent wire 2a changes, there is no electric contact between the adjacent wires 2a. For this reason, the electric resistance on a signal input side of the electric cord 2 does not change, and noise is not generated.

Even though the wire 2a is disconnected, the wire 2a is not in contact with another adjacent wire 2a at the disconnection portion. Even though the electric resistance on the signal input side of the electric cord 2 is increased by the disconnection, the electric resistance is not changed by vibration generated during operation of the loudspeaker. In addition, electromagnetic noise is not generated by alternation of contact and non-contact states.

Therefore, when the electric cord 2 described in the first embodiment is used as a wire rod for guiding an input signal to a loudspeaker, noise is not generated by a change in contact resistance based on vibration during operation of a loudspeaker, and electromagnetic noise is not generated. For this reason, high-quality noise can be reproduced.

### SECOND EMBODIMENT

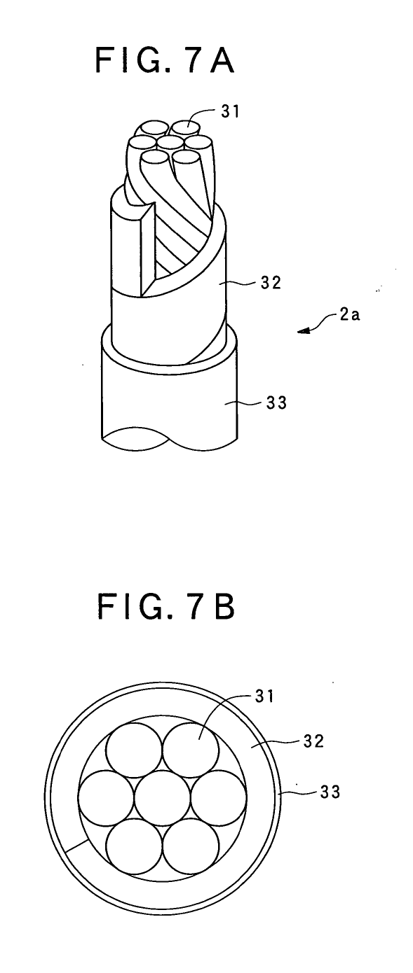

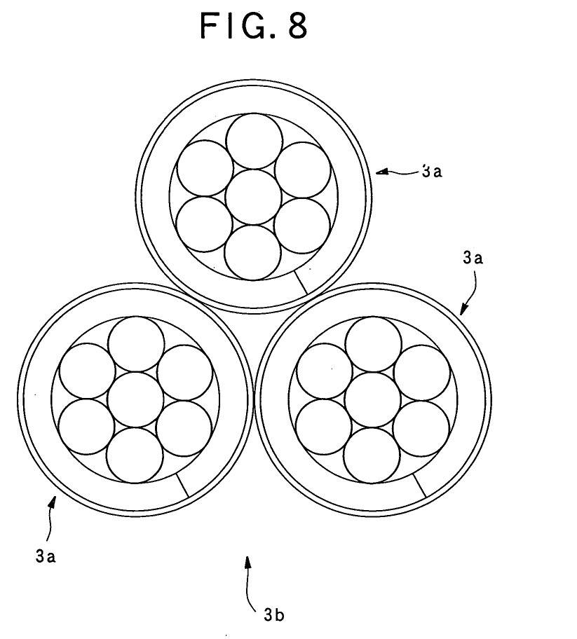

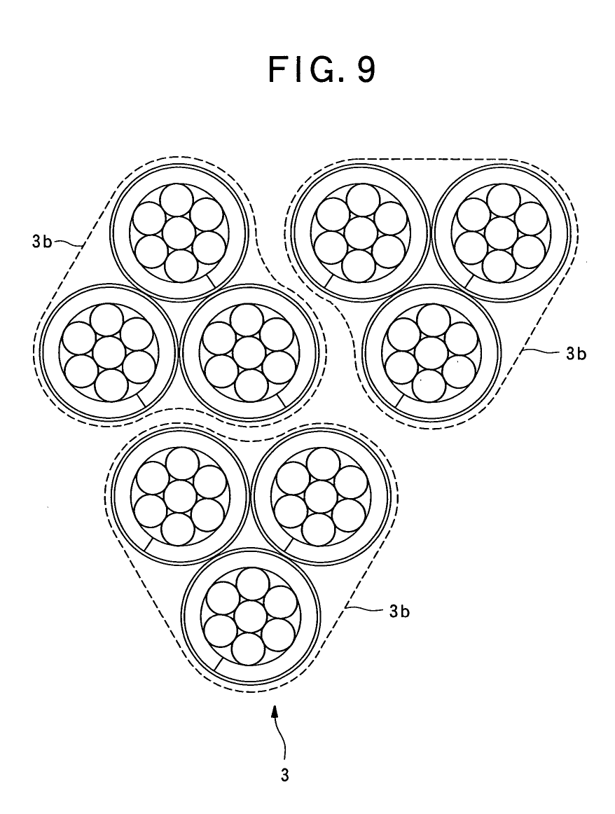

A second embodiment in which an electric cord according to the present invention is applied as a conductive lead for a loudspeaker will be described below with reference to FIGS. 7A to 9. FIGS. 7A and 7B are views showing the structure of a wire according to the second embodiment of the present invention, in which FIG. 7A is a perspective view and FIG. 7B is a sectional view. FIG. 8 is a sectional view of a wire rod formed by using three wires shown in FIGS. 7A and 7B, and FIG. 9 is a sectional view of an electric cord formed by using three wire rods shown in FIG. 8.

As shown in FIGS. 7A and 7B, a wire 3a is obtained by winding a conductor 32 on a center core obtained by twisting a plurality of core threads 31. The external side of the conductor 32 winded on the core threads 31 is covered with an insulator 33. A tube or the like consisting of a resin is preferably used as the insulator 33. As the conductor 32, a rectangular wire rather than a round wire is preferably used with respect to volume occupation. More specifically, a large current can be passed through the conductor without increasing the area of the winding section.

A plurality of wires 3a shown in FIGS. 7A and 7B, e.g., three wires, constitute a wire rod 3b as shown in FIG. 8. These three wires 3a are twisted, woven, or bundled to form the wire rod 3b. A plurality of wire rods 3b described above are used to form an electric cord.

A plurality of wire rods 3b as shown in FIG. 8, e.g., three wire rods, constitute an electric cord 3 as shown in FIG. 9. These three wire rods 3b are twisted, woven, or bundled to form the electric cord 3.

In the electric cord 3 having the above structure, since the surface of the wire 3a constituting the electric cord 3 is insulated, the wire 3a is not in electric contact with another wire 3a. A conductor for inputting a signal to a loudspeaker has an end fixed to an input terminal attached to a frame and the other end connected to a voice coil. For this reason, the conductor is vibrated and deformed. In particular, when a high-frequency signal is inputted, or when a high voltage is inputted, the vibration or deformation becomes conspicuous.

The application of vibration or deformation may change the contact state between the wire 3a and another adjacent wire 3a to disconnect the wire 3a. However, even though the contact state between a wire 3a having a surface covered with an insulator and another adjacent wire 3a changes, there is no electric contact between the adjacent wires 3a. For this reason, the electric resistance on a signal input side of the electric cord 3 does not change, and noise is not generated.

Even though the wire 3a is disconnected, the wire 3a is not in contact with another adjacent wire 3a at the disconnection portion. Even though the electric resistance on the signal input side of the electric cord 3 is increased by the disconnection, the electric resistance is not changed by vibration generated during operation of the loudspeaker. In addition, electromagnetic noise is not generated by alternation of contact and non-contact states.

Therefore, when the electric cord 3 described in the second embodiment is used as a wire rod for guiding an input signal to a loudspeaker, noise is not generated by a change in contact resistance based on vibration during operation of a loudspeaker, and electromagnetic noise is not generated. For this reason, high-quality noise can be reproduced.

(Example of loudspeaker to which electric cord according to the present invention is applied)

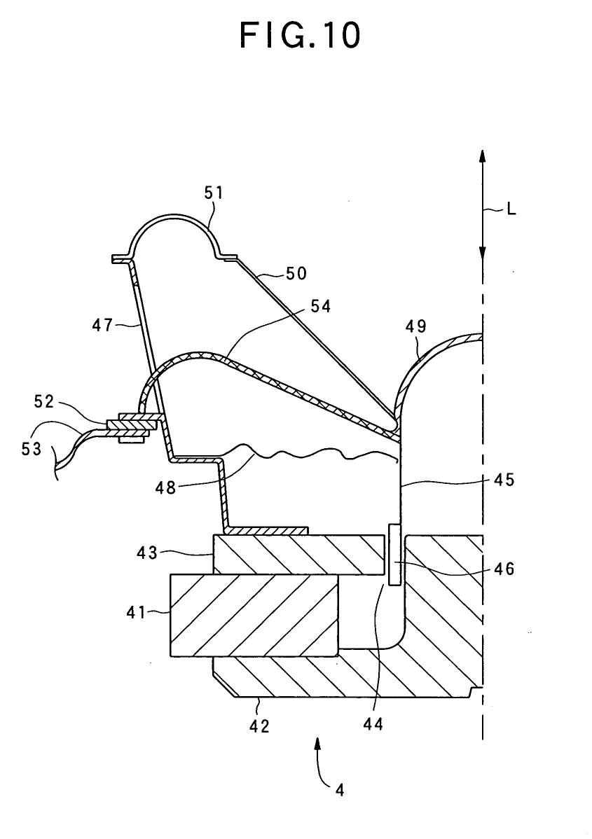

A loudspeaker in which an electric cord according to the present invention is applied as a conductive lead for a loudspeaker will be described below with reference to FIG. 10. FIG. 10 is a sectional view showing the left half of an external-magnet type loudspeaker.

A loudspeaker 4 comprises a magnetic circuit constituted by a yoke 42 and a plate 43 which interpose a ring-like magnet 41 therebetween. A voice coil 46 which is coaxially winded on a voice coil bobbin 45 is inserted into a magnet gap 44 formed between the yoke 42 and the plate 43.

A frame 47 is fixed to a surface of the plate 43 opposing the magnet 41. A dumper 48 is arranged between the frame 47 and the voice coil bobbin 45, and a voice coil 46 is suspended by a dumper 48 to prevent the voice coil 46 from being in contact with the yoke 42 and the plate 43 in the magnet gap 44. The distal end of the voice coil bobbin 45 is adhesively fixed to a diaphragm 50 by a dust cap 49.

A loudspeaker edge 51 couples the peripheral portion of the diaphragm 50 to the peripheral portion of the frame 47. The loudspeaker edge 51 is easily transformed on the basis of vibration of the diaphragm 50. And loudspeaker edge 51 supports the motion of the diaphragm 50 with respect to the frame 47.

Furthermore, an input terminal 52 is provided on a predetermined part on the outside of the frame 47. By using the input terminal 52 as a terminal, a drive current from a wire lead 53 is supplied to the voice coil 46 through a conductive lead (electric cord) 54.

When a signal is inputted to the voice coil 46, a magnetic flux having the same direction as the radial direction of the magnet gap 44 and a coaxial current flowing in the voice coil 46 generate force in a direction indicated by an arrow L. The force vibrates the diaphragm 50 in the direction indicated by the arrow L to convert the vibration into sound. At this time, the loudspeaker edge 51 is transformed depending on displacement of the diaphragm 50 to support the position of the diaphragm 50.

As the electric cord 54 used here, the electric cord 2 described in the first embodiment of the present invention or the electric cord 3 described in the second embodiment is preferably used. As described above, in the operations and advantages of these electric cords, even though the adjacent wires 2a or 3a are brought into contact with each other or disconnected, the electric resistance on the input side does not change. For this reason, a current flowing in the voice coil 46 varies depending on an input signal level. Therefore, the diaphragm 50 vibrates depending on the input signal level. Since a mechanical resistance is extremely small, the diaphragm 50 vibrates faithfully to an input signal, and a high-quality voice output can be obtained.

The present invention is not limited to the above embodiment. The invention can be properly changed without departing from the gist or spirit of the invention read from the scope of claims and the whole specification. Electric cords according to the above changes and loudspeakers using the electric cords are also included in the technical idea of the present invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-340653 filed on Nov. 25, 2002 including the specification, claims, drawings and summary is incorporated herein by reference in its entirety.

What is claimed is:

1. An electric cord comprising a plurality of wires which electrically connect a vibrator and an input terminal to which a drive signal for driving the vibrator is inputted, wherein
the respective wires are electrically insulated from each other.

2. The electric cord according to claim 1, wherein the electric cord is formed by at least one of twisting, weaving, and bundling a plurality of wire rods each of which is formed by at least one of twisting, weaving, and bundling of the plurality of wires.

3. The electric cord according to claim 1, wherein the wire is constituted by a core thread and a conductor winded on the surface of the core thread, and the surface of the conductor is covered with an insulator.

4. The electric cord according to claim 1, wherein the wire is constituted by a core thread and a conductor winded on the surface of the core thread, and the surface of the wires is covered with an insulator.

5. The electric cord according to claim 3, wherein the conductor is a rectangular conductor having a rectangular section.

6. The electric cord according to claim 4, wherein the conductor is a rectangular conductor having a rectangular section.

7. A loudspeaker using an electric cord, wherein the electric cord is an electric cord according to claim 1, and the electric cord is used as a signal input line for a voice coil.
